(19) United States
(12) Patent Application Publication
(10) Pub. No.: US 2012/0116845 A1
(43) Pub. Date: May 10, 2012

(54) SYSTEM FOR REAL-TIME RESPONDENT SELECTION AND INTERVIEW AND ASSOCIATED METHODS

(76) Inventors: Matt Warta, Denver, CO (US); Carl Rossow, Denver, CO (US); Adam Kramer, Denver, CO (US)

(21) Appl. No.: 13/291,071

(22) Filed: Nov. 7, 2011

Related U.S. Application Data
(60) Provisional application No. 61/410,463, filed on Nov. 5, 2010.

(51) Int. Cl. G06Q 10/00

(52) U.S. Cl. 705/7.32

(57) ABSTRACT

A system and a method to implement real-time respondent selection and interview. A real-time evaluator selects a respondent in real-time for interview with a user of the system, where the respondent selection is based upon criteria defined by the user. An interview manager conducts the interview between the user and the respondent and records a transcript of the interview.

### RELATED APPLICATIONS

This application claims priority to U.S. Patent Application Ser. No. 61/410,463, titled “System for Real-Time Respondent Selection and Interview and Associated Methods”, filed Nov. 5, 2010, and incorporated herein by reference.

### BACKGROUND

The term “Respondents” is used herein to denote a group of people who have agreed to participate in surveys and interviews in return for compensation, such as payment and/or coupons. These respondents may be categorized and represented within a database of a panel company such that one or more of these respondents may be selected based upon criteria specified by a third party. The criteria may include one or more of gender, age group, marital status, geographic area, income band, and so on. A third party wishing to conduct a market analysis for a new product may specify selection criteria that identifies a portion of the market and a survey (e.g., a list of questions) to a marketing organization. The marketing organization interacts with the panel company to identify respondents that meet the specified criteria within the database and sends each respondent the survey for completion. Respondents that receive this survey typically respond (e.g., online to a server of the marketing company) at their convenience. The marketing organization processes the returned surveys to provide the third party with a market analysis. It may take several weeks from the time the third party specifies the criteria and the survey to the time the marketing organization returns the market analysis to the third party.

The marketing organization may also utilize a moderator to interactively interview selected respondents upon the request of the third party. In this case, respondents are selected and scheduled (e.g., using emails and phone calls to contact potential respondents) for future interview by the moderator, who interacts with each selected respondent in turn to collect survey results for processing. It may take several weeks from the time the third party specifies the criteria and the survey to the time the marketing organization returns the market analysis to the third party.

### SUMMARY

In one embodiment, a computer implemented real-time respondent selection and interview system includes a real-time evaluator and an interview manager. The real-time evaluator selects a respondent in real-time for interview with a user of the system, where the respondent selection is based upon criteria defined by the user. The interview manager conducts the interview between the user and the respondent and records a transcript of the interview.

In another embodiment, a computer implemented method implements real-time selection and interview of a respondent by a user. An indication from each of a plurality of potential respondents willing to participate in the interview is received in a server. Each potential respondent is evaluated, interactively in real time, against criteria specified by the user. The respondent is selected, within the server, for interview from the potential respondents that match the criteria. The interview is conducted between the respondent and the user.

### BRIEF DESCRIPTION OF THE FIGURES

FIG. 1 shows one exemplary system for real-time respondent selection and interview, in an embodiment.

FIG. 2 shows the system of FIG. 1 in further detail illustrating selection of respondents for interview by a user based upon at least criteria defined by the user.

FIG. 3 shows the system of FIGS. 1 and 2 performing an interview between the user and a respondent.

FIG. 4 shows one exemplary computer system that may implement the server of FIG. 1, in an embodiment.

FIG. 5 shows one exemplary real-time respondent selection and interview process, in an embodiment.

FIG. 6 shows one exemplary process for facilitating an interview between the user and the selected respondent, in an embodiment.

FIG. 7 shows one exemplary screen wherein the user may initially select types of question that are to be used to form the custom criteria, in an embodiment.

FIG. 8 shows one exemplary screen where the user has entered one exemplary question and associated multiple choice answers with respondent selection logic, in an embodiment.

FIG. 9 shows one exemplary screen for display to a respondent illustrating one example questions and multiple choice answers that form the custom criteria of FIG. 2, in an embodiment.

FIG. 10 shows one exemplary screen that is displayed to a respondent who does not meet the custom criteria of FIG. 2, in an embodiment.

FIG. 11 shows one exemplary screen illustrating upload of an image into the media/link list of FIG. 2 by the user, in an embodiment.

FIG. 12 shows one exemplary screen illustrating selection of one image from the media/link list of FIG. 2 displayed within a tab area, in an embodiment.

FIG. 13 shows one exemplary screen, displayed to a respondent during an interview with the user, illustrating display of the image selected by the user on the screen of FIG. 12.

FIG. 14 shows one exemplary screen displayed to a respondent when that respondent clicks on the image within the screen of FIG. 13.

FIG. 15 shows one exemplary screen, displayed to a respondent during an interview between the user and the respondent, illustrating display of a link within a chat window.

FIG. 16 is a data flow diagram illustrating management of respondents by the real-time evaluator of FIGS. 1 and 2, in an embodiment.

FIG. 17 is a flowchart illustrating one exemplary process for controlling flow of respondents within the system of FIGS. 1, 2 and 3, in an embodiment.

FIG. 18 shows one exemplary system that is similar to the system of FIGS. 1, 2 and 3, and includes a proxy partner for interacting with one or more alternative servers to provide real-time respondent selection for interview, in an embodiment.

FIG. 19 is a flowchart illustrating one exemplary process for providing real-time respondent selection for interview, in an embodiment.

FIG. 20 shows one exemplary system illustrating selection of respondents for an asynchronous survey based upon criteria defined by a user, in an embodiment.

FIG. 21 shows the system of FIG. 20 interacting with respondents to complete the survey, in an embodiment.

FIG. 22 is a flowchart illustrating one exemplary process for selecting respondents to participate in a survey, in an embodiment.

FIG. 23 shows one exemplary screen shot illustrating a tab area displaying a portion of the question list of FIGS. 2 and 3.

FIG. 24 is a flowchart illustrating one exemplary process 2400 for interacting with user and respondents participating in a survey.

### DETAILED DESCRIPTION OF THE EMBODIMENTS

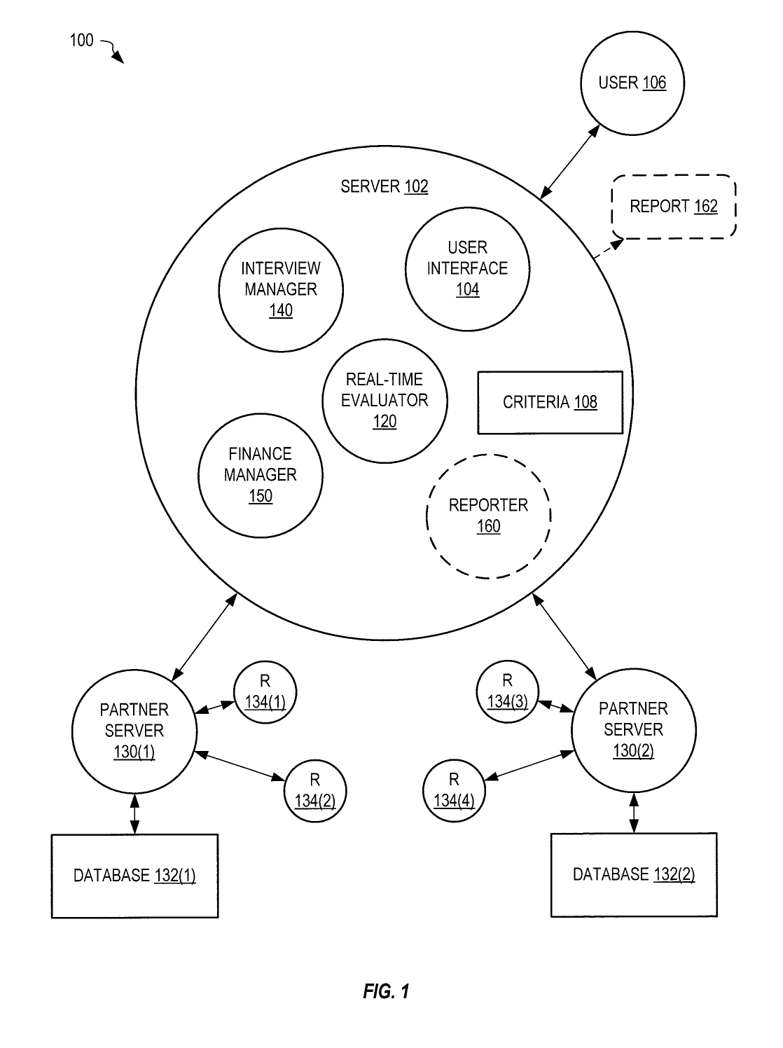

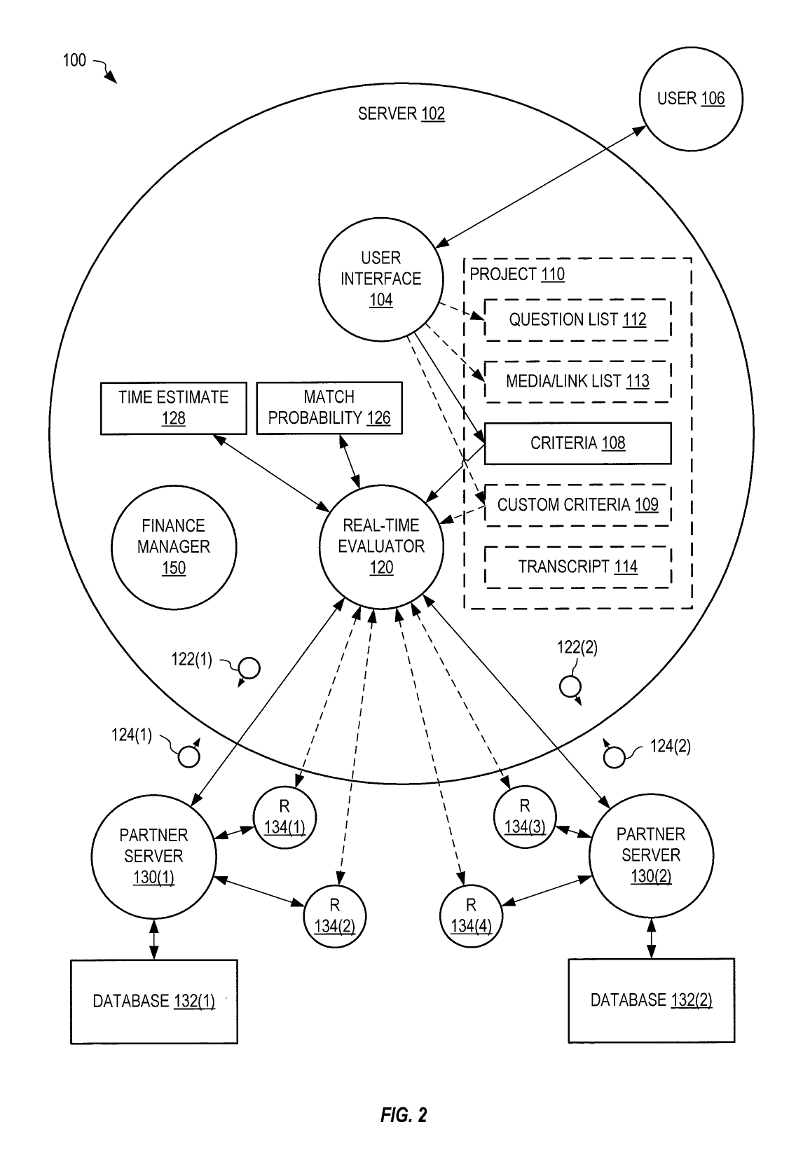

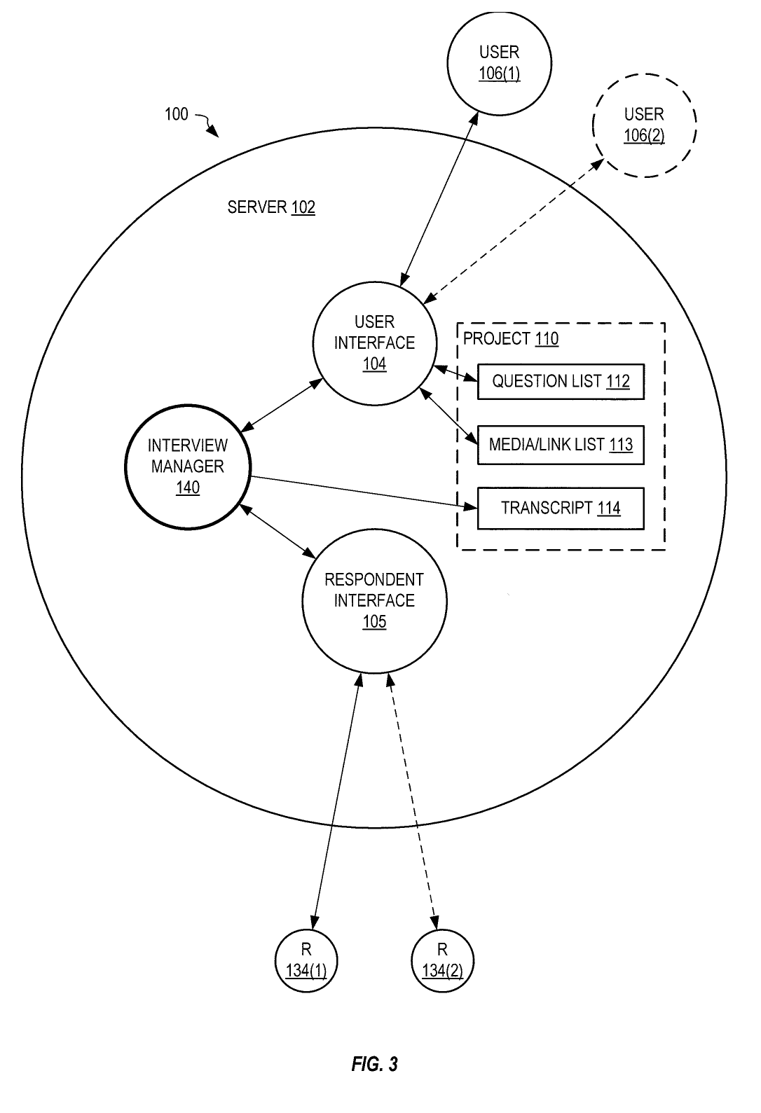

FIG. 1 shows one exemplary system 100 for real-time respondent selection and interview. System 100 is implemented as a server 102 that provides a user interface 104 to one or more users 106. User interface 104 may represent a web server that provides a web interface to user 106, wherein user 106 interacts with system 100 via one or more web pages of user interface 104. FIG. 2 shows system 100 of FIG. 1 in further detail illustrating selection of respondents 134 for interview by user 106 based upon at least criteria 108 defined by user 106. FIG. 3 shows system 100 of FIGS. 1 and 2 performing an interview between user 106 and respondent 134. FIGS. 1, 2 and 3 are best viewed together with the following description.

System 100 is communicatively connected with at least one partner server 130, external to system 100, which utilizes a database 132 to store information of a plurality of respondents 134. Partner server 130 is for example provided by one or both of a panel company and a social media site. Respondents 134 subscribe to partner server 130 and participate in surveys and interviews in cooperation with partner server 130. Database 132 stores characteristics pertaining to each respondent 134 such as age, gender, marital status, geographic area, and so on. Partner server 130 also tracks connectivity of respondents 134. For example, partner server 130 may utilize database 132 to store date and time information of respondent 134 access to partner server 130. In the example of FIG. 1, system 100 is shown connected with partner server 130(1) that has a database 132(1) and communicates with respondents 134(1) and 134(2), and with partner server 130(2) that has a database 132(2) and communicates with respondents 134(3) and 134(4).

User 106 interacts with user interface 104 to define criteria 108. Criteria 108 are for example demographic requirements of respondents 134 that user 106 wishes to interview. These demographic criteria include age range, gender, household income, geographic area, marital status, children in household, employment status, education level and ethnicity. For example, user could indicate that respondents 134 will match criteria 108 if they are between the ages of 25-49, are female, have children under 10 in their household, and live in California. Optionally, user 106 may create a project 110 that contains criteria 108 and other information, such as a question list 112 and optional media/link list 113, associated with the desired interview. A real-time evaluator 120 interacts with at least one partner server 130 to select respondents 134 that match criteria 108 and that are immediately available for interview by user 106.

Server 102 may also include a finance manager 150 that manages an account for user 106 that accrues cost based upon interviews by user 106 of respondents 134. For example, each interview made by user 106 incurs a charge that is accumulated by financial manager 150 and is billed to user 106. Finance manager 150 calculates a cost for the interview based upon criteria 108, custom criteria 109 (shown in FIG. 2) if used, the length of the interview between user 106 and respondent 134, and any bonus incentive offered to the respondent.

Server 102 also includes an interview manager 140 that provides an interface to facilitate a one-on-one interview or a one-on-many interview between user 106 and one or more selected respondents 134 utilizing user interface 104 and a respondent interface 105 (shown in FIG. 3). Respondent interface 105 is for example a web based interface for interacting with one or more respondents 134.

Optionally, server 102 may also include a reporter 160 for generating a report detailing transcription (e.g., transcript 114 of FIG. 2) of interviews and summary of respondent demographics, for example. In one embodiment, reporter 160 generates report 162 in Adobe® PDF format that may be downloaded from system 100 by user 106.

As user 106 interacts with user interface 104 to enter criteria 108 (and optional custom criteria 109), real-time evaluator 120 sends a message 122(1) to partner server 130(1) containing information of criteria 108 and a period (time window). The period defines a time window during which eligible respondents 134 have communicated with partner server 130. For example, the period may be defined as ten minutes, indicating that respondents are eligible for interview if they have connected to the partner server within the last ten minutes and match criteria 108.

Partner server 130 searches database 132 for respondents 134 that match information of message 122, and sends a message 124 back to real-time evaluator 120 indicating the number of potential respondents for interview. In one example of operation, partner server 130(1) identifies respondents 134(1) and 134(2) as matching information within message 122(1), and sends message 124(1) back to real-time evaluator 120 indicating that two respondents are available. Similarly, real-time evaluator 120 sends message 122(2) to partner server 130(2) and in return receives message 124(2) indicating the number of potential respondents associated with partner server 130(2).

Based upon information (e.g., messages 124) received from partner servers 130, system 100 determines and displays to user 106 a probability of selecting an appropriate respondent for online interview. For example, real-time evaluator 120 determines, based upon information of messages 124, a match probability 126 that is displayed on a webpage generated by user interface 104 and viewed by user 106. Match probability is determined by an algorithm with the independent variables of the total respondent count on partner server 130 that match the criteria 108, the number of those respondents who have communicated with partner server 130 in the last 30 minutes, the narrowness of the demographic screening criteria 108, the amount of custom criteria 109, and the time of day. Thus, user 106 has a real-time indication as to probability of finding a suitable respondent for interview based upon input criteria 108. In one example of operation, where criteria 108 is too narrow, real-time evaluator 120 may determine that the probability of finding a respondent available for interview is 0%. User 106 may then adjust criteria 108 until an acceptable probability of finding the suitable respondent is achieved. In one embodiment, match probability 126 is displayed as one of ‘easy’, ‘medium’, and ‘hard’. Continuing with the above example, when criteria 108 is narrow (e.g., a specific small geographic area), or user 106 is interacting with user interface 104 at a time (e.g., 4:00 AM) when few respondents 134 are connected to partner server 130, respondent match probability 126 may be determined as ‘hard’.

Real-time evaluator 120 may also determine a time estimate 128 for delivering a respondent for interview by user 106. For example, based upon the number of potential respondents, returned from partner server 130 and other information such as the current time of day, real-time evaluator 120 provides a time estimate 128 for selecting and preparing a respondent for online interview by user 106, which is typically a few minutes. Time estimate 128 may be derived by the same algorithm that determines match probability 126.

In preparation for an interview with the selected respondent 134, user 106 interacts with user interface 104 to create question list 112. For example, user 106 may create question list 112 in advance of specifying criteria 108 and participating in an interview. Question list 112 may be used to prompt user 106 during an interview and allows user 106 to select appropriate questions easily.

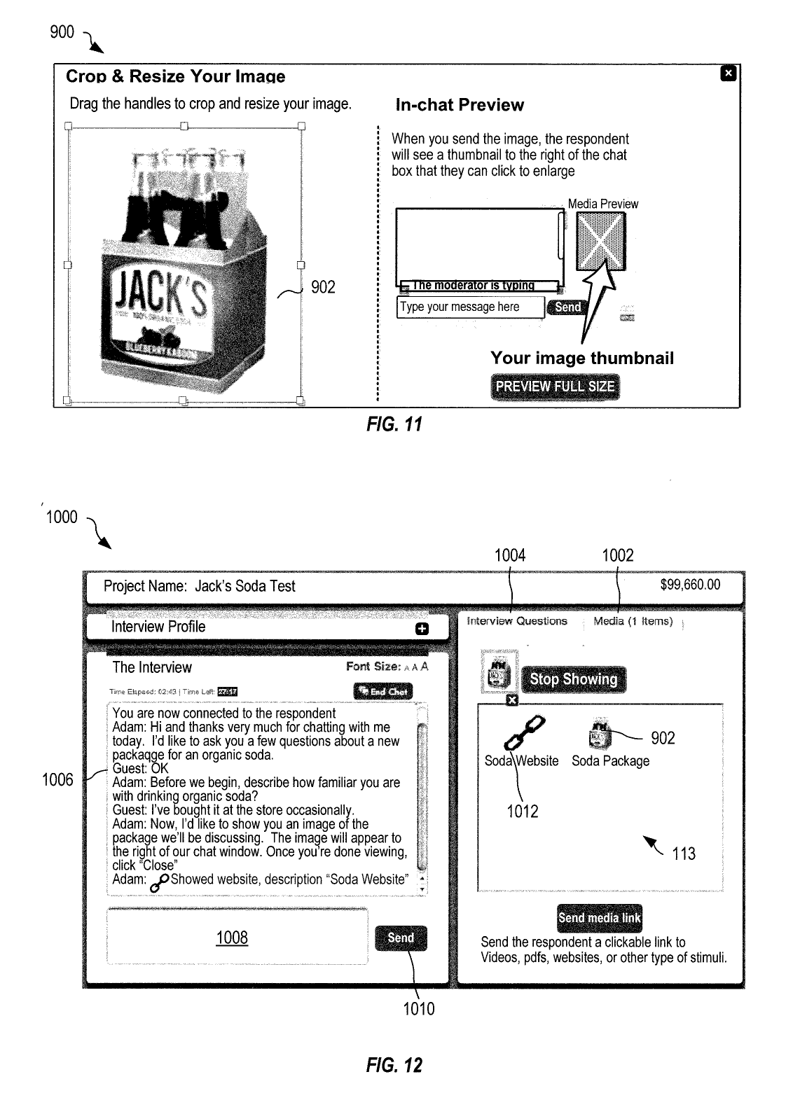

Optionally, user interface 104 also allows user 106 to create a media/link list 113 that contains one or more of digital media (e.g., images, audio, and video) and links (e.g., URLs and hyperlinks) to web sites that provide digital media. FIG. 11 shows one exemplary screen 900 illustrating upload of an image 902 into media/link list 113 by user 106. FIG. 12 shows one exemplary screen 1000 illustrating image 902 and link 1012 from media/link list 113 displayed within a tab area 1002 for selection by user 106 during an interview with respondent 134. FIG. 23 shows one exemplary screen shot 2300 illustrating tab area 1004 displaying a portion of question list 112. FIGS. 12 and 23 also show a chat window 1006, a text entry window 1008 and a send button 1010 for interaction with user 106.

Once user 106 determines that the indicated match probability 126 of finding a respondent for interview and the time estimate 128 for initiating the interview are acceptable, user 106 indicates via user interface 104 that system 100 should proceed with the interview.

Real-time evaluator 120 determines a respondent requirement (number of respondents to evaluate) and requests that number of respondents from partner server 130. The respondent requirement is typically less than the number of respondents available from partner server 130 that match criteria 108. For example, partner server may identify thousands of available respondents that match criteria 108, whereas real-time evaluator 120 may determine the respondent requirement as ten. Real-time evaluator 120 may request additional respondents 134 as needed, such as when further processing/interrogation of respondents 134 results in elimination of one or more of those provided by partner server 130. Real-time evaluator 120 then interactively verifies that each respondent 134 provided by partner server 130 meet criteria 108.

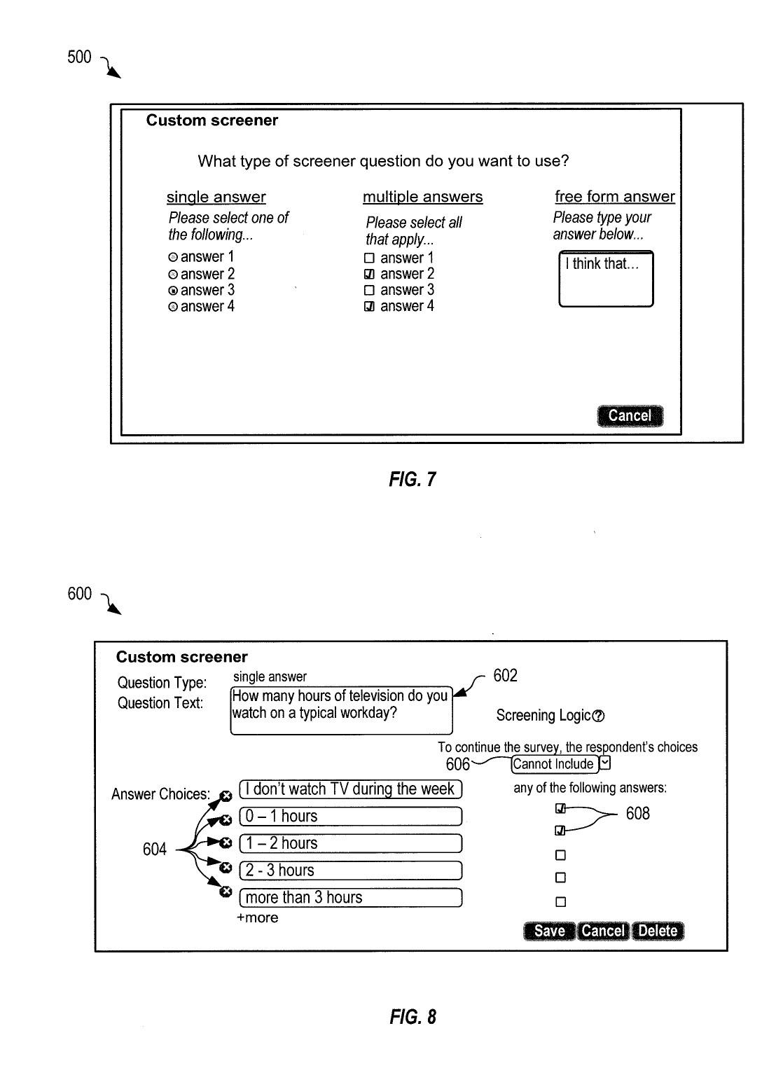

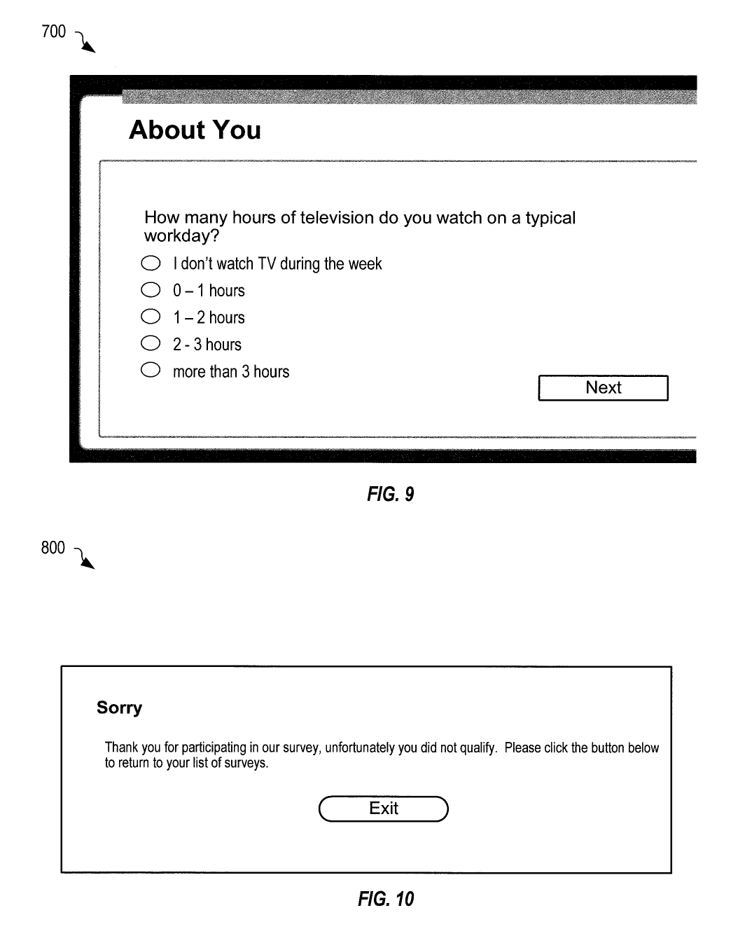

Optionally, real-time evaluator 120 may also automatically and interactively evaluate provided respondents 134 against custom criteria 109 supplied by user 106. Custom criteria 109 may include one or more questions that are used by system 100 to further qualify respondents 134 for interview by user 106. In one example of operation, user 106 interacts with user interface 104 to interactively create custom criteria 109 that defines additional criteria for selecting respondents 134 for interview. FIG. 7 shows one exemplary screen 500 wherein user 106 initially selects the types of question that are to be used to form custom criteria 109, and FIG. 8 shows one exemplary screen 600 where user 106 has entered one exemplary question 602 and associated multiple choice answers 604, and then defined the respondent selection logic 606, 608 applied to received answers. For example, user 106 may specify logic that excludes respondent 134 if certain answers are received, as in the example of FIG. 8, and may specify logic that includes respondent 134 if certain answers are received.

Where custom criteria 109 is supplied by user 106, after selection of the first number of respondents 134 from partner servers 130 based upon criteria 108, real-time evaluator 120 evaluates each of the first number of respondent 134 against custom criteria 109 through direct interaction with each respondent. Real-time evaluator 120 eliminates respondents that do not meet custom criteria 109. In one example of operation, real-time evaluator 120 displays screen 700 of FIG. 9 to each respondent 134, and eliminates the respondent as a potential for interview when respondent selection logic 606, 608 determines that the respondent's answer indicates that the respondent is not suitable for interview. FIG. 10 shows one exemplary screen 800 that is displayed to a respondent 134 that does not meet custom criteria 109, after which communication with the respondent is terminated (i.e., the respondent is released).

One respondent 134 is then selected by real-time evaluator 120 from respondents 134 that have been determined as meeting criteria 108, and optional custom criteria 109, for interview by user 106.

Interview manager 140 cooperates with user interface 104 and respondent interface 105 to implement a one on one interview between user 106(1) and respondent 134(1), for example. In one embodiment, interview manager 140 conducts a one-on-many interview wherein user 106(1) interviews respondents 134(1) and 134(2) concurrently, for example. In another example, interview manager 140 allows user 106(1) to interview respondent 134(1) at the same time as user 106(2) interviews respondent 134(2), where both user 106(1) and 106(2) share the same project 110. That is, both users 106(1) and 106(2) cooperate to create project 110 and utilize questions list 112 and media/link list 113 of project 110 during separate, and optionally concurrent, interviews.

In one embodiment, user interface 104 and respondent interface 105 facilitate text and image based communication between user 106 and respondents 134, similar to an instant messaging interface, known in the art. In another embodiment, user interface 104 and respondent interface 105 facilitate video chatting between user 106 and one or more respondents 134.

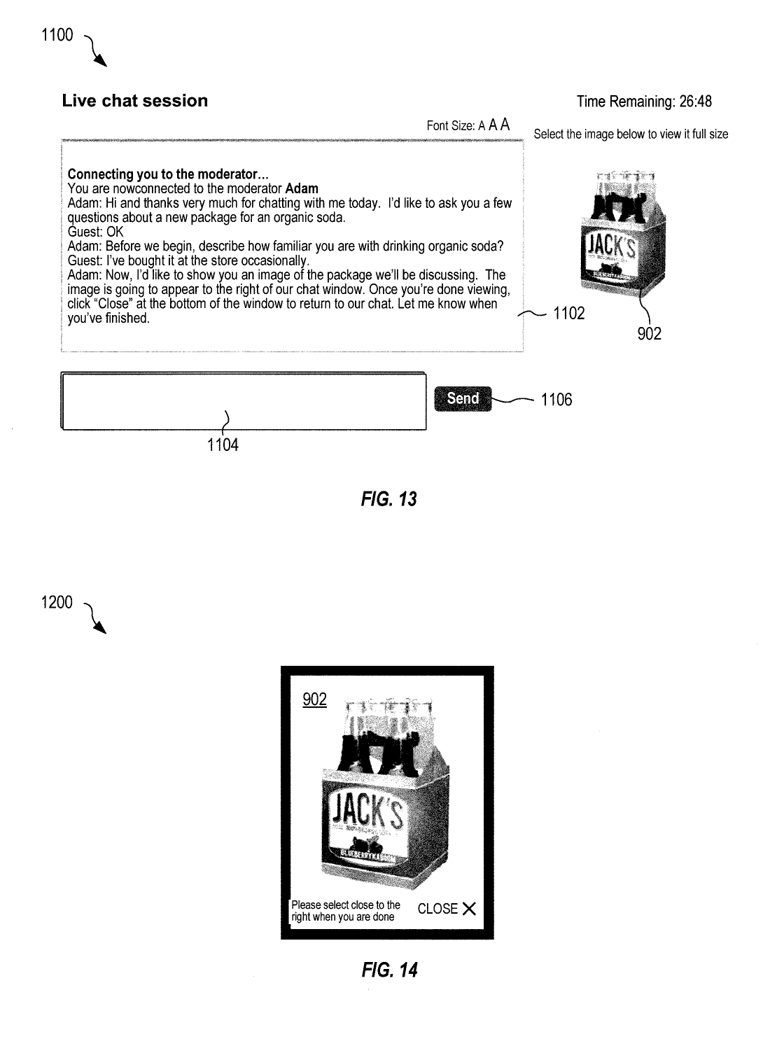

FIG. 13 shows one exemplary screen 1100, displayed to respondent 134 during an interview with user 106, illustrating display of image 902 when selected by user 106 on screen 1000 of FIG. 12. Screen 1100 also shows a chat window 1102, a text entry area 1104, and a send button 1106. FIG. 14 shows a screen 1200 displayed to respondent 134 when the respondent clicks on image 902 within screen 1100.

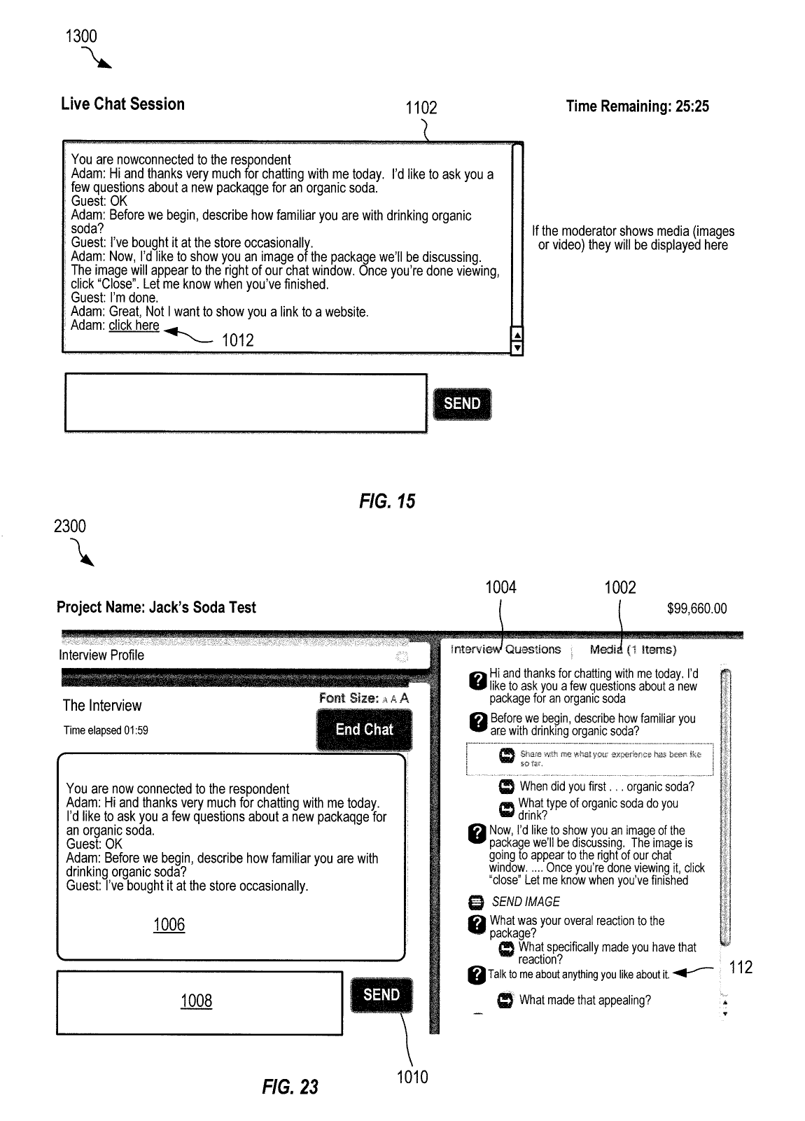

FIG. 15 shows one exemplary screen 1300, displayed to respondent 134 during an interview between user 106 and respondent 134, illustrating display of media/link 1012 within chat window 1102 when selected by user 106 from media/link list 113 on screen 1000 of FIG. 12. For example, media/link 1012 may be displayed within tab area 1002 for selection by user 106.

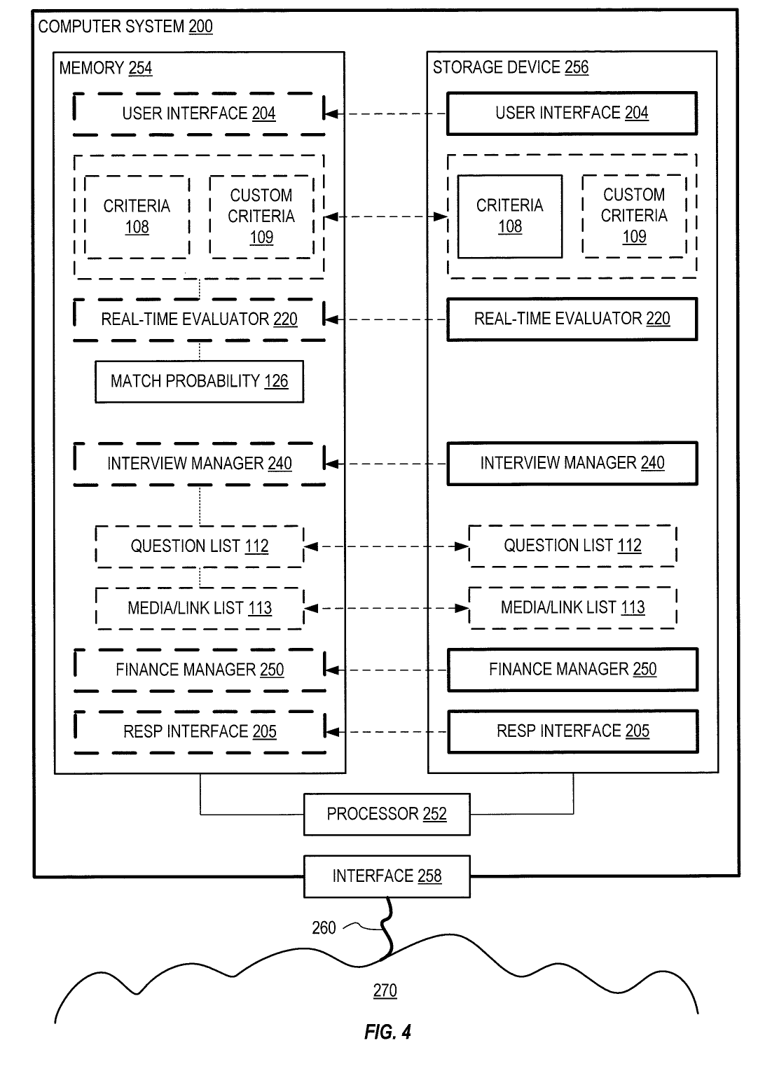

FIG. 4 shows one exemplary computer system 200 that may represent server 102 of FIGS. 1, 2 and 3. System 200 has a processor 252, a memory 254, and a storage device 256. Computer system 200 may include more processors 252, memories 254 and storage devices 256 without departing from the scope hereof. For example, system 200 may include multiple processors that are in communication with memory 254 and storage device 256. In one embodiment, storage device 256 is external to computer system 200 (e.g., a network storage device) and accessed via an interface of system 200. System 200 is shown storing criteria 108, custom criteria 109, question list 112, and media link list 113 within storage device 256, from where it is loaded, at least in part, into memory 254. System 200 may include an interface 258 that has one or more connections 260 with a network 270. Network 270 may represent one or more of a local network, a wide area network, and the Internet. Storage device 256 represents a non-volatile memory such as one or more of a disc drive, a database, and a network storage device. Interface 258 may support one or more protocols for accessing network 270, such as TCP/IP and other Internet protocols.

Storage device 256 stores functional modules (e.g., software modules) that include instructions that when loaded, at least in part, into memory 254 and executed by processor 252 implement functionality of system 100, FIGS. 1, 2, and 3. Functional models stored within storage device 256 include a user interface 204 that implements functionality of user interface 104; a respondent interface 205 that implements functionality of respondent interface 105; a real-time evaluator 220 that implements functionality of real-time evaluator 120 to create match probability 126; an interview manager 240 that implements functionality of interview manager 140; and a finance manager 250 that implements functionality of finance manager 150.

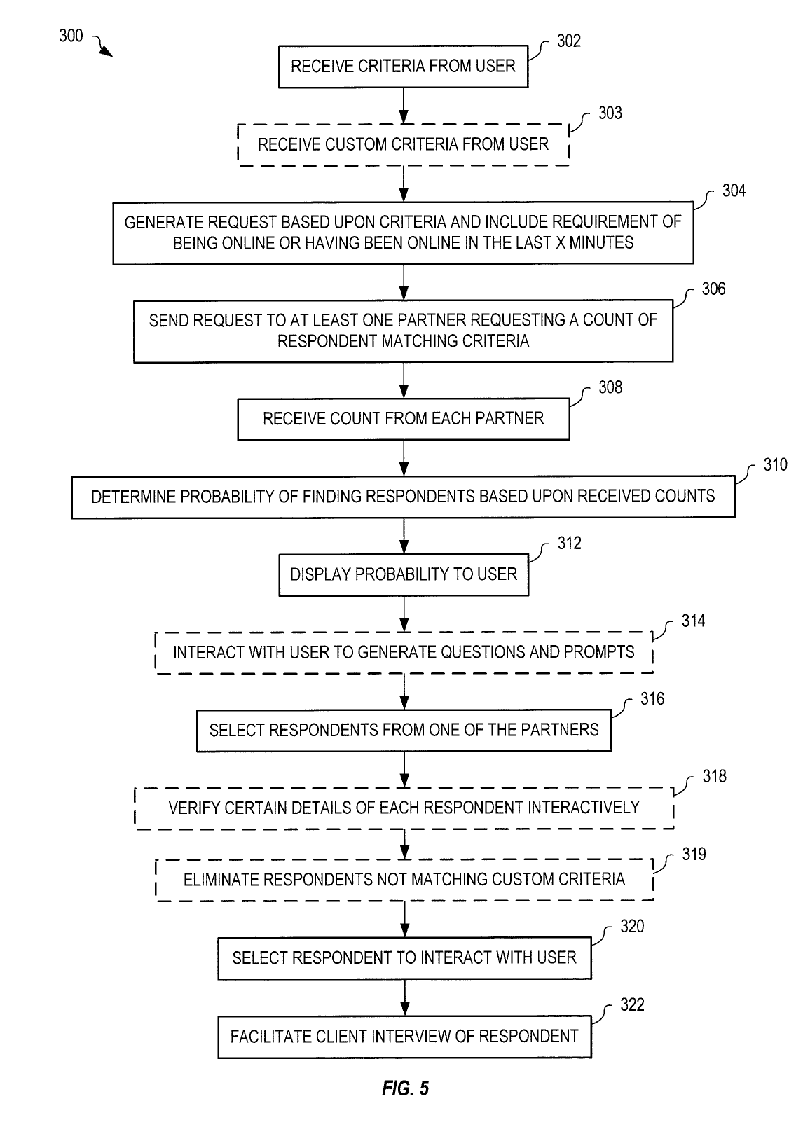

FIG. 5 shows one exemplary real-time respondent selection and interview process 300. In step 302, process 300 receives criteria from a user. In one example of step 302, user interface 104 of server 102 interacts with user 106 to receive criteria 108. Step 303 is optional. If included, in step 303, process 300 receives custom criteria from the user. In one example of step 303, user interface 104 of server 102 interacts with user 106 to receive custom criteria 109. In step 304, process 300 generates a request based upon the criteria and includes a requirement of being online or having been online in the last X minutes. In one example of step 304, real-time evaluator 120 generates message 122 that includes information of criteria 108 and a requirement of being online or having been online within the last 10 minutes. In step 306, process 300 sends the request to each of a plurality of partners to request a count of respondents matching the criteria. In one example of step 306, real-time evaluator 120 sends message 122(1) to partner server 130(1) and sends message 122(2) to partner server 130(2).

In step 308, process receives a count from each partner. In one example of step 308, real-time evaluator 120 receives message 124(1) containing a first count from partner server 130(1) and receives message 124(2) from partner server 130(2) containing a second count. In step 310, process 300 determines a probability of finding respondents based upon the counts received in step 308. In one example of step 310, real-time evaluator 120 processes the first and second counts received in messages 124 to determine match probability 126. In step 312, process 300 displays the probability to the user. In one example of step 312, real-time evaluator 120 displays match probability 126 to user 106 via user interface 104.

Step 314 is optional. If included, in step 314, process 300 interacts with the user to generate questions and prompts. In one example of step 314, user interface 104 interacts with user 106 to generate question list 112.

In step 316, process 300 selects respondents from one of the partners. In one example of step 316, real-time evaluator 120 interacts with partner server 130(1) to select a first number of respondents 134 meeting criteria 108 and receives information from partner server 130(1) for each selected respondent. Step 318 is optional. If included, in step 318, process 300 verifies certain details of each respondent interactively. In one example of step 318, real-time evaluator 120 interacts with each respondent 134 to verify current details of the respondent against criteria 108. Step 319 is optional. If included, in step 319, process 300 eliminates respondents not matching custom criteria. In one example of step 319, real-time evaluator 120 interacts with each respondent 134 selected in step 316 to determine whether the respondent matches custom criteria 109 specified by user 106.

In step 320, process 300 selects one respondent for interaction with the user. In one example of step 320, real-time evaluator 120 selects one respond 134 and for interview by the user 106. In step 322, process 300 conducts the user's interview of the respondent. In one example of step 322 real-time evaluator 120 instructs interview manager 140 to cooperate with user interface 104 and respondent interface 105 to facilitate an interview between user 106 and respondent 134(1).

It should be noted that ordering of steps within process 300 may change without departing from the scope hereof. For example, step 314 may occur prior to any of steps 302 though 312.

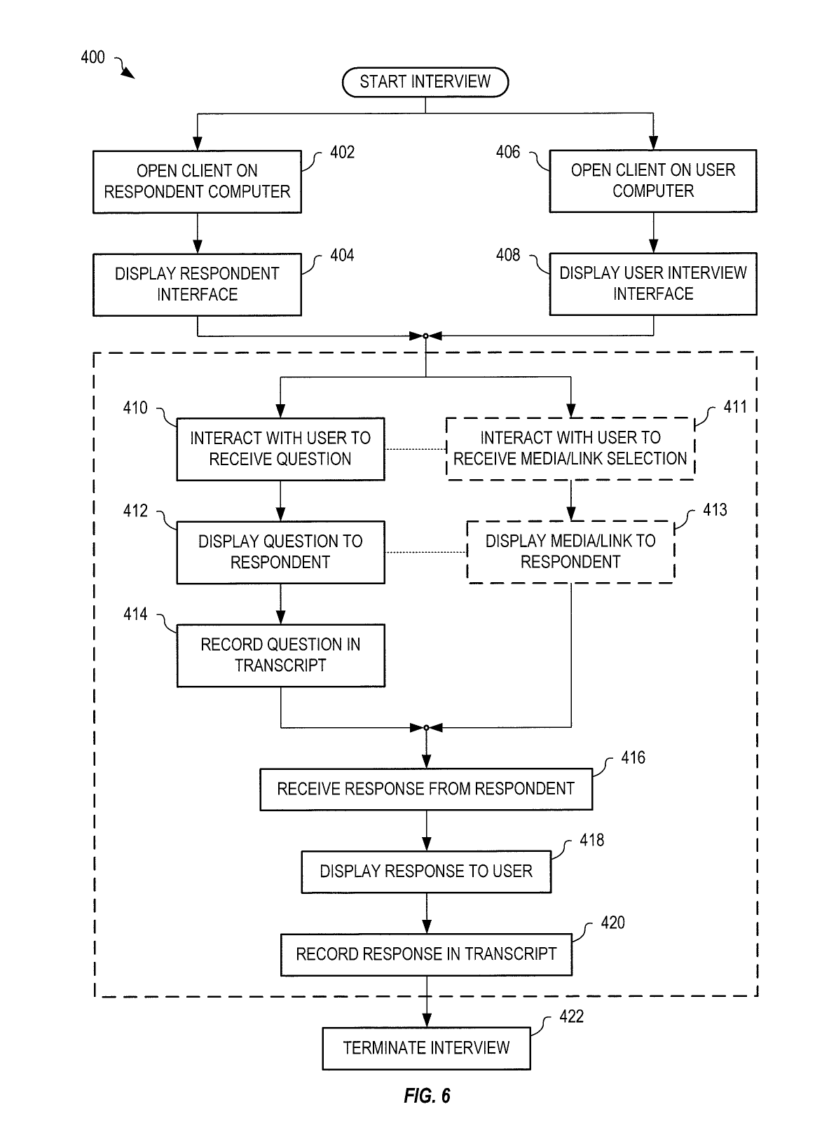

FIG. 6 shows one exemplary process 400 for facilitating an interview between the user and the selected respondent. Process 400 is for example implemented by one or more of user interface 204, real-time evaluator 220, and interview manager 240. In step 402, process 400 opens a client application on the selected respondent's computer. In one example of step 402, interview manager 140 runs a client interface on the computer of respondent 134(1). In step 404, process 400 displays a respondent interface. In one example of step 404, interview manager 140 displays the respondent interface using the client of step 402.

In step 406, process 400 opens a client on the user's computer. In one example of step 406, interview manager 140 cooperates with user interface 104 to run the client on the computer of user 106. In step 408, process 400 displays a user interview interface. In one example of step 408, interview manager 140 cooperates with user interface 104 and the client of step 406, to display an interview interface to user 106. Steps 402, 404 and 406, 408 may occur concurrently as shown, or made be implemented serially, without departing from the scope hereof.

In step 410, process 400 interacts with the user to receive a question. In one example of step 410, user 106 selects the prepared question from question list 112. In step 412, process 400 displays the question to the respondent. In one example of step 412, interview manager 140 sends the selected question to the client interface running on the computer of respondent 134(1). In step 414, process 400 records the question in a transcript. In one example of step 414, interview manager 140 records the question in transcript 114. Transcript 114 may represent one or more files for recording questions and responses together or apart, without departing from the scope hereof.

Steps 411 and 413 are optional and may be implemented in parallel to, or serially with, steps 410, 412 and 414. In step 411, process 400 interacts with the user to receive a media/link selection. In one example of step 411, user interface 104 interacts with user 106 to receive selection of a media and/or link from media/link list 113. In step 413, process 400 displays the selected media/link to the respondent. In one example of step 413, interview manager 140 sends the selected media/link to respondent 134 via respondent interface 105.

In step 416, process 400 receives a response from the respondent. In one example of step 416, interview manager 140 receives a response from the client running on the computer of respondent 134(1). In step 418, process 400 displays the response from the respondent to the user. In one example of step 418, interview manager 140 cooperates with user interface 104 to display the response from respondent 134(1) to user 106. In step 420, process 400 records the respondent's response in the transcript. In one example of step 420, interview manager 140 records the response from respondent 134(1) in transcript 114.

Steps 410 through 420 repeat for the duration of the interview between the user and the respondent. For example, steps 410 through 420 repeat for the duration of the interview between user 106 and respondent 134(1).

In step 422, process 400 terminates the interview. In one example of step 422, upon indication from user 106 that the interview is complete, interview manager 140 closes and/or disconnects from the client on the computer of respondent 134(1), and instructs user interface 104 to close and/or disconnect from the interview interface on the computer of user 106.

User 106 may continue interaction with user interface 104 to access transcript 114 and review the respondent's responses.

Finance manager 150 cooperates with partner server 130(1) to provide compensation to respondent 134(1) for participating in the interview with user 106, and add a charge to the account of user 106.

During the interview between user 106 and respondent 134, user 106 may elect to extend the interview, wherein the respondent 134 is offered an additional (bonus) incentive for extending the length of the interview. For example, where user 106 find that the interview with respondent 134(1) is particularly insightful, user 106 elects to extend the interview with respondent 134(1), wherein, if respondent 134(1) agrees, respondent 134(1) receives a bonus incentive. When the offer to extend the interview is accepted by respondent 134(1), financial manager 150 automatically debits the account of user 106 by an appropriate amount, and credits respondent 134(1) via partner server 130(1). For example, the credit to the respondent may represent one or more of a financial amount, a coupon, a gift token, and so on.

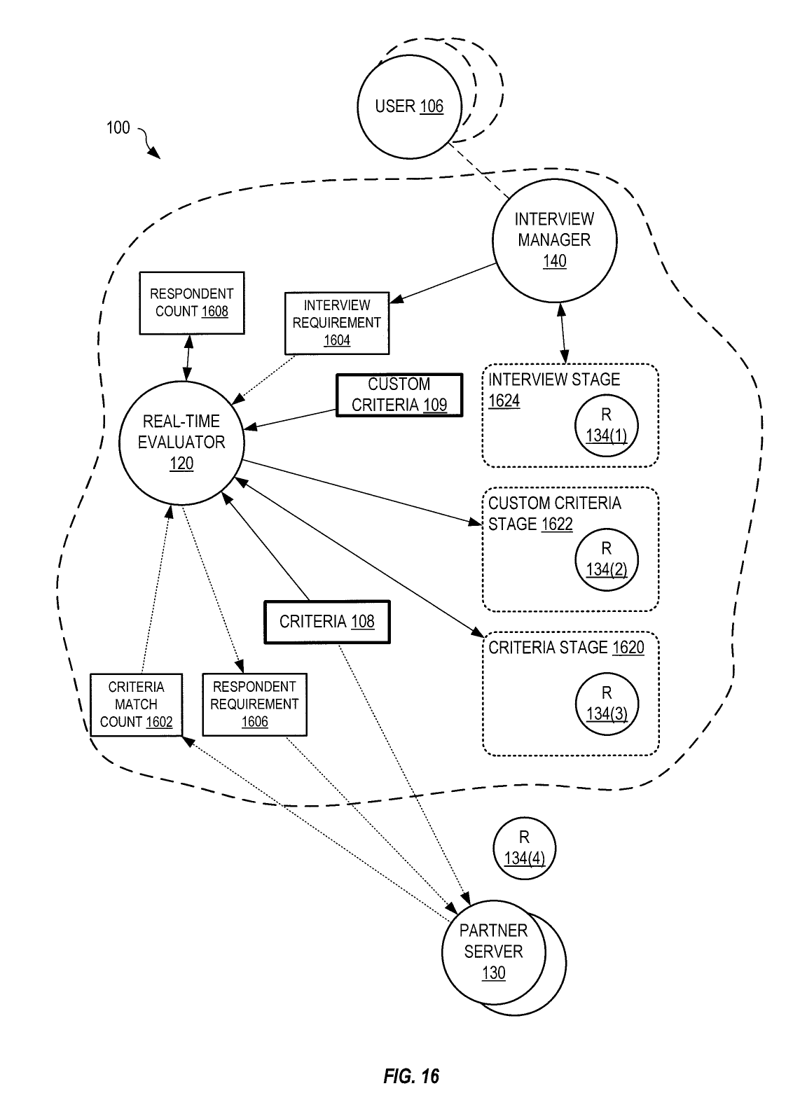

FIG. 16 is a data flow diagram illustrating management of respondents 134 by system 100, FIG. 1, in preparation for, and during, an interview with a user 106. As described above, real-time evaluator 120 sends criteria 108 to partner server 130, whereupon partner server 130 sends a criteria match count 1602 defining the number of respondents that match criteria 108 (and are likely available for interview) in return. Interview manager 140 determines an interview requirement 1604 based upon the number of user 106 that are ready to interview respondents selected based upon criteria 108. For example, where a single user 106 requests an interview with a respondent, interview manager 140 may set interview requirement 1604 to one. In another example, where user 106(1) and user 106(2) are cooperating within project 110 of FIGS. 2 and 3, and each requests to interview a respondent using the same criteria 108 and questions list 112, interview manager 140 defines interview requirement 1604 as two.

Real-time evaluator 120 then calculates a respondent requirement 1606 based upon one or more of interview requirement 1604, criteria 108, custom criteria 109 if provided, criteria match count 1602, match probability 126, and time estimate 128. For example, real-time evaluator 120 may determine respondent requirements 1606 as ten where interview requirement 1604 is one and criteria 108 (and custom criteria 109) indicate relatively broad demographics and match probability 126 is determined as ‘easy’.

Partner server 130 then provides respondents 134 (or information thereon) to real-time evaluator 120 as they become available (e.g., are online and agree to participate in an interview).

Real-time evaluator 120 maintains a respondent count 1608 of respondents being processed by system 100. For example, real-time evaluator 120 increases respondent count 1608 as each new respondent is received from partner server 130 and decreases respondent count 1608 as respondents are dropped from system 100. In the example of FIG. 16, respondent count 1608 is three, and would increase to four when respondent 134(4) is moved into stage 1620. In the example of FIG. 16, partner server 130 provides respondents 134(1)-(4) to system 100, one at a time as they accept the invitation to participate in the survey.

Real-time evaluator 120 passes each respondent 134 first through a criteria stage 1620 wherein respondent 134 is evaluated against criteria 108. If respondent 134 matches criteria 108, respondent 134 then moves to custom criteria stage 1622. If respondent 134 does not match criteria 108, the respondent is dropped from system 100 and respondent count 1608 is decreased by one. In the example of FIG. 16, if respondent 134(3) does not match criteria 108, respondent 134(3) is dropped from system 100 and respondent count 1608 is decreased by one.

In custom criteria stage 1622, real-time evaluator 120 evaluates respondent 134 against custom criteria 109 if provided. If respondent 134 does not match custom criteria 109, the respondent is dropped from system 100 and respondent count 1608 is decreased by one. If respondent 134 matches custom criteria 109, the respondent moves into interview stage 1624 to await interview. In the example of FIG. 16, when respondent 134 transitions to interview stage 1624 and interview requirement 1604 is satisfied (e.g., sufficient respondents have reached interview stage 1624), real-time evaluator 120 sets respondent requirement 1606 to zero to indicate to partner servers 130 that no further respondents are currently needed, and real-time evaluator 120 drops respondents (e.g., respondents 134(2) and 134(3)) within stages 1620 and 1622, from system 100.

As shown in FIG. 16, respondent 134(1) has passed through criteria stage 1620, custom criteria stage 1622, and is within interview stage 1624 and awaiting an interview with user 106 that is managed by interview manager 140; respondent 134(2) is being evaluated by against custom criteria 109 having first been evaluated by real-time evaluator 120 against criteria 108; respondent 134(3) is being evaluated by real-time evaluator 120 against criteria 108, and respondent 134(4) has become available and is being passed to system 100 from partner server 130. Respondents 134 are processed asynchronously by system 100 wherein zero, one, or more respondents may be within each of stages 1620 and 1622. When respondent 134(1) is selected for interview, and more respondents are not needed, real-time evaluator 120 sets respondent requirement 1606 to zero, thereby indicating to each partner server 130 that no more respondents are required. However, if respondents 134 provided by partner server 130 do not match criteria 108 or custom criteria 109, and interview requirement 1604 has not been fulfilled, real-time evaluator 120 may increase respondent requirement 1606 such that partner servers 130 provide further respondents 134 as they become available.

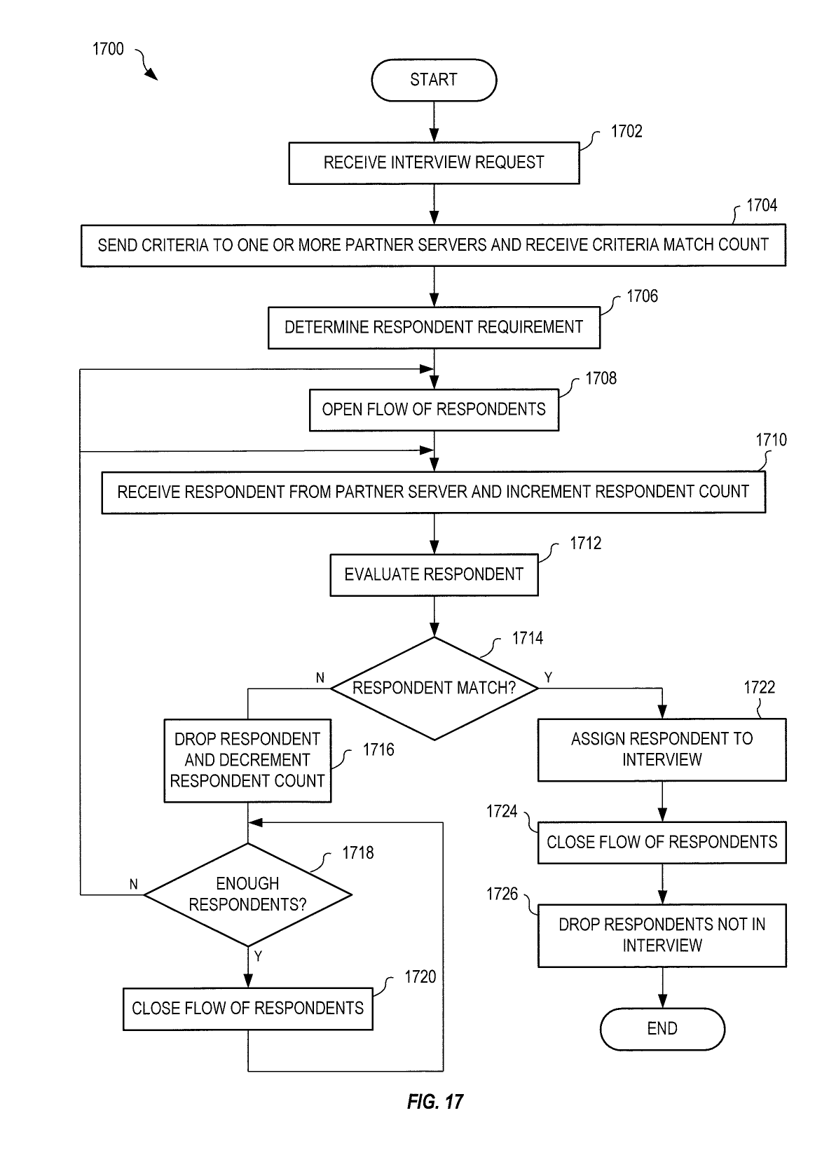

FIG. 17 is a flowchart illustrating one exemplary process 1700 for controlling flow of respondents 134 within system 100 of FIG. 1. Process 1700 is implemented by real-time evaluator 120, for example.

In step 1702, process 1700 receives an interview requirement. In one example of step 1702, real-time evaluator 120 receives an interview requirement 1604 based upon a number of users 106 waiting to conduct interviews with respondents from interview manager 140. In step 1704, process 1700 sends criteria to one or more partner servers and receives a criteria match count from each server. In one example of step 1704, real-time evaluator 120 sends criteria 108 to each partner server 130 and receives a criteria match count 1602 from each partner server. In step 1706, process 1700 determines a respondent requirement. In one example of step 1706, real-time evaluator 120 determines respondent requirement 1606 based upon one or more of criteria 108, custom criteria 109, criteria match count 1602, interview requirement 1604, match probability 126, and time estimate 128.

In step 1708, process 1700 opens flow of respondents from the partner servers. In one example of step 1708, real-time evaluator 120 sends a command to each partner server 130 to start recruiting and sending respondents 134 to system 100. In step 1710, process 1700 receives a respondent from one partner server and increments the respondent count. In one example of step 1710, real-time evaluator 120 receives respondent 134(4) from partner server 130 and increments respondent count 1608 by one. In step 1712, process 1700 evaluates the respondent. In one example of step 1712, real-time evaluator 120 evaluates respondent 134(3) against criteria 108 and custom criteria 109 if provided.

Step 1714 is a decision. If, in step 1714, process 1700 determines that the respondent is a match, process 1700 continues with step 1722; otherwise process 1700 continues with step 1716. In step 1716, process 1700 drops the respondent and decrements the respondent count. In one example of step 1716, real-time evaluator 120 drops respondent 134(3) that does not match criteria 108 and decrements respondent count 1608.

Step 1718 is a decision. If, in step 1718, process determines that enough respondents have been received, process 1700 continues with step 1720; otherwise process 1700 continues with step 1708 when flow of respondents has been stopped or step 1710 if flow of respondents has not been stopped. In step 1720, process 1700 closes flow of respondents from the partner servers if not already closed. In one example of step 1720, real-time evaluator 120 sends a message to each partner server 130 indicating that no further respondents 134 are currently required. Process 1700 continues with step 1718.

In step 1722, process 1700 assigns the respondent to an interview. In one example of step 1722, real-time evaluator 120 sends respondent 134(1) to interview manager 140 for assignment to an interview with user 106. In step 1724, process 1700 closes flow of respondents from the partner servers. In one example of step 1724, real-time evaluator 120 sends a message to each partner server 130 indicating that further respondents 134 are not required. In step 1726, process 1700 drops respondents not in the interview. In one example of step 1726, real-time evaluator 120 drops respondents 134(2) and 134(3). Process 1700 then terminates.

It should be noted that steps 1710 through 1726 may repeat for each respondent 134 received from partner server 130.

### Non-Panel Company Recruitment

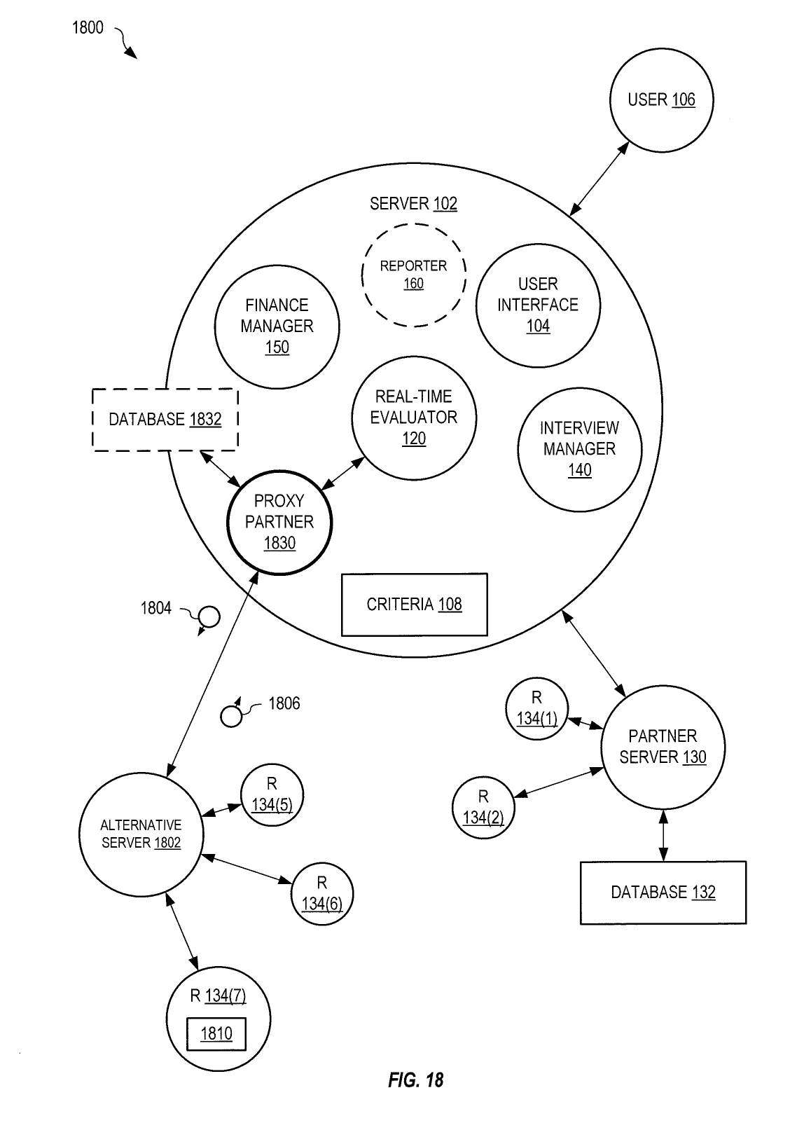

FIG. 18 shows one exemplary system 1800 that is similar to system 100, and includes a proxy partner 1830 for interacting with one or more alternative servers 1802. Alternative server 1802 may represent one or more of a social networking server (e.g., Facebook and Twitter), a corporate web site (e.g., a web site of a corporation, company, or organization), and a private web site (e.g., a web site visible only internally to an organization). Respondents 134(5) and 134(6) are subscribers (members) of alternative server 1802 and are currently in communication therewith.

Proxy partner 1830 appears similar (e.g., has a similar communication interface) to partner server 130 from the perspective of real-time evaluator 120. However, proxy partner 1830 accesses alternative server 1802 to identify respondents (e.g., respondents 134(5) and 134(6)) for interview by user 106. In one example of operation, proxy partner 1830 receives criteria 108 from real-time evaluator 120 and sends an invite 1804 via alternative server 1802 to each of respondents 134(5) and 134(6). Respondents 134(5) and 134(6) may then send a message 1806, in response to invite 1804, via alternative server 1802 for example, to proxy partner 1830 indicating their willingness to participate in an interview. Proxy partner 1830 may utilize a database 1832 for storing information of each respondent 134(5) and 134(6). In one embodiment, respondents 134(5) and 134(6) are registered with proxy partner 1830 (e.g., via alternative server 1802) wherein database 1832 is used to store demographic information of each respondent. Proxy partner 1830 may then evaluate respondents wishing to participate in the interview using criteria 108 to determine a number of respondents (similar to partner server 130).

In one embodiment, where alternative server 1802 represents a social media server, a social media site (e.g., a Facebook page) is configured within alternative server 1802 to correspond to proxy partner 1830 such that respondents 134(5) and 134(6) may register with proxy partner 1830 via the social media site.

In another embodiment, a respondent 134(7) is a subscriber to alternative server 1802 and utilizes an application 1810, running on a mobile communication device for example. Application 1810 may facilitate direct communication with proxy partner 1830 and other components of server 102. In one example of operation, proxy partner 1830 utilizes alternative server 1802 to initiate communication with respondent 134(7), wherein application 1810 allows respondent 134(7) to immediately respond to proxy partner 1830.

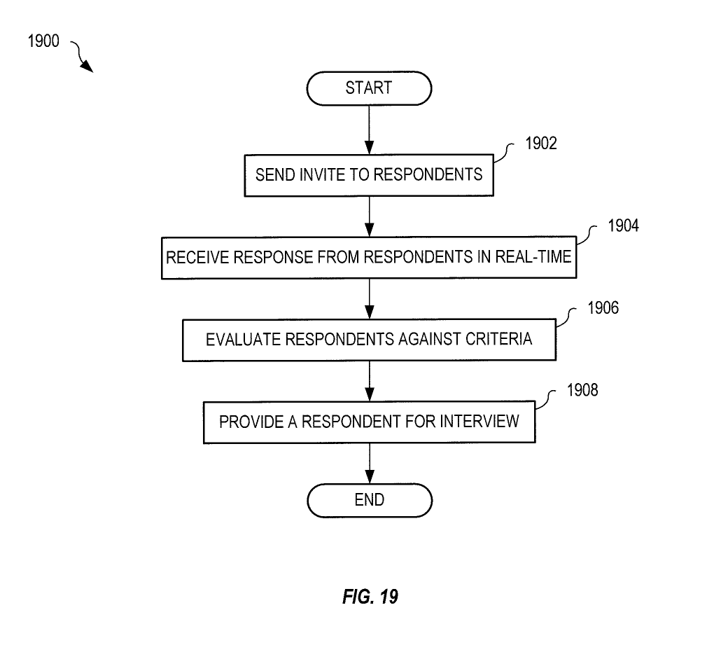

FIG. 19 is a flowchart illustrating one exemplary process 1900 for providing real-time respondent selection for interview, in an embodiment. Process 1900 is for example implemented by proxy partner 1830, real-time evaluator 120, user interface 104, and interview manager 140.

In step 1902, process 1900 sends an invite to respondents. In one example of step 1902, real-time evaluator 120 sends invite 1804 to respondents 134(5) and 134(6) via proxy partner 1830 and alternative server 1802. In step 1904, process 1900 receives a response from respondents in real-time. In one example of step 1904, proxy partner 1830 receives message 1806 from respondent 134(5) via alternative server 1802. In step 1906, process 1900 evaluates the respondents against the criteria. In one example of step 1906, real-time evaluator 120 evaluates respondents 134(5), 134(6), and 134(7) against criteria 108 and optionally against custom criteria 109. In step 1908, process 1900 provides a respondent for interview. In one example of step 1908, interview manager 140 provides respondent 134(5) for interview with user 106.

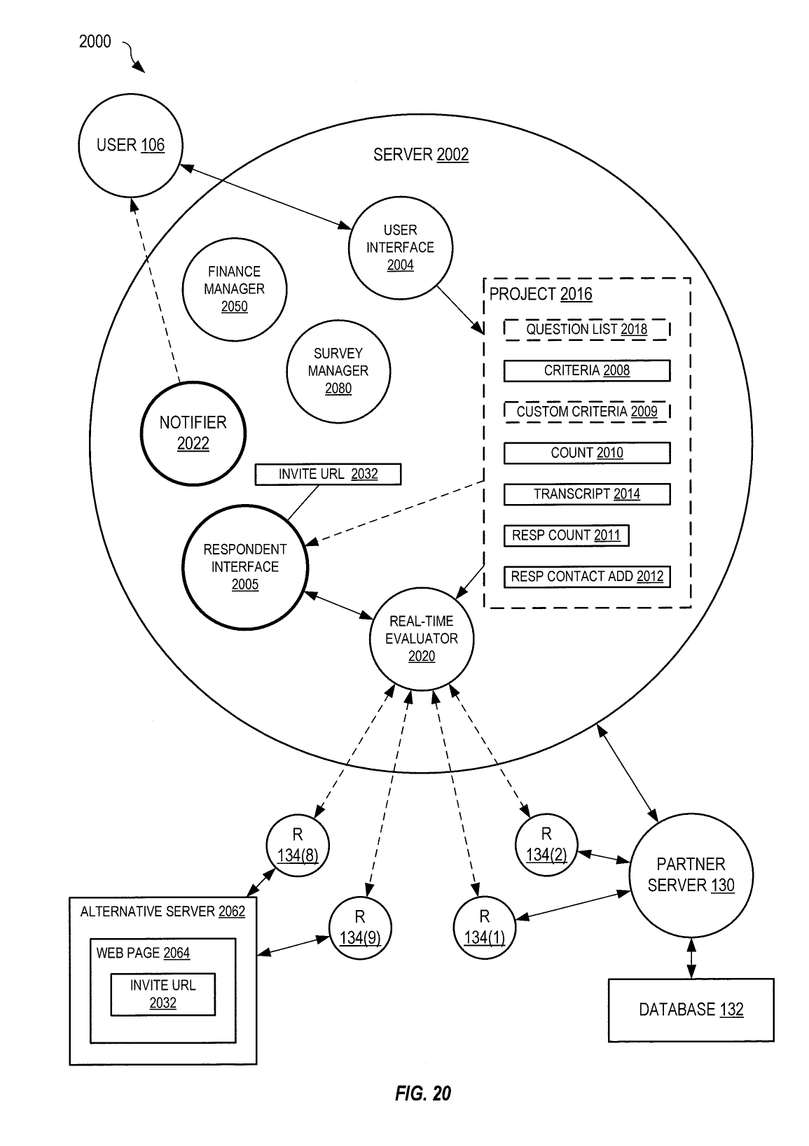

FIG. 20 shows a system 2000 illustrating selection of respondents 134 for asynchronous survey based upon at least criteria 2008 defined by user 106. System 2000 is implemented as a server 2002 and includes a user interface 2004, a real-time evaluator 2020, a respondent interface 2005, and a finance manager 2050. System 2000 is similar to system 100 of FIG. 1, wherein user interface 2004 is similar to user interface 104, real-time evaluator 2020 is similar to real-time evaluator 120, respondent interface 2005 is similar to respondent interface 105, and finance manager 2050 is similar to finance manager 150.

System 2000 operates to select respondents 134 based upon criteria 2008 and optional custom criteria 2009. Criteria 2008 and criteria 2009 are similar to criteria 108 and custom criteria 109, respectively, and are entered by user 106 interacting with user interface 2004. For example, user 106 interacts with user interface 2004 to create a project 2016 that includes criteria 2008 and optional custom criteria 2009 that defines criteria that each respondent must match, and indicating that the questions are for an asynchronous type survey. User 106 also enters (or selects) a count 2010 indicating the desired number of respondents 134 that user 106 would like to complete the survey. User 106 also creates a question list 2018 that may include media and links for use in the survey. Finance manager 2050 may determine a cost for the survey based upon one or more of the number of questions (e.g., in question list 2018), criteria 2008, custom criteria 2009, count 2010, and the source of respondents (e.g., Facebook, web site, partner server 130).

Respondent interface 2005 is configured with a first web page addressed by an invite URL 2032 and user 106 is provided invite URL 2032 for inclusion on one or more web pages. User 106 configures a web page 2064 of an alternative server 2062 with invite URL 2032 such that a viewer (e.g., respondents 134(8) and 134(9)) of web page 2064 may select a button (or other selectable item) configured with invite URL 2032 to participate in the survey. For example, where alternative server 2062 represents a Facebook® server, invite URL 2032 may be included on a Facebook® page associated with a business of user 106. In another example, where alternative server 2062 represents a web server associated with user 106, invite URL 2032 may be included on a web page of a corporate web site of user 106. User 106 may thereby solicit viewers of particular web pages to participate the survey associated with project 2016.

Each respondent 134 interacts with the first web page (and optionally other web pages accessed from the first web page) to provide a respondent contact address 2012 for receiving notifications from system 2000. Respondent contact address 2012 is stored by respondent interface 2005 in association with project 2016 and is for example an email address and/or a telephone number for receiving text messages. Real-time evaluator 2020 evaluates, through respondent interface 2005, each respondent 134 that selects invite URL 2032 against criteria 2008 and optional custom criteria 2009, to identify respondents 134 that are suitable for the survey.

Real-time evaluator 2020 determines a respondent count 2011 based upon count 2010 and one or more of criteria 2008, custom criteria 2009, that indicates a desired number of respondents 134 to participate in the survey to allow for attrition. For example, real-time evaluator 2020 may set respondent count 2011 to be 30% greater than count 2010 to allow for respondents 134 that do not complete all questions of the survey. Real-time evaluator 2020 may also increase respondent count 2011 to allow additional respondents to participate in the survey where the number of respondents that are eliminated by criteria 2008 and custom criteria 2009 result in insufficient participants in the survey.

Real-time evaluator 2020 notifies user 106 once the number of identified respondents suitable for participating in the survey reaches respondent count 2011, such that user 106 may remove invite URL 2032 from web page 2064 to prevent further respondents from applying to participate. If the number of respondents participating in the survey drops below count 2010, real-time evaluator 2020 may notify user 106, wherein user 106 may reinstate invite URL 2032 on web page 2064 to increase the number of respondents, or wherein user 106 may elect to utilize respondents selected from partner server 130 to participate in the survey.

Each respondent 134 eligible for the survey is asked a first question of question list 2018 to initiate the survey by respondent interface 2005. Respondent interface 2005 stores the response from the respondent within a transcript 2014 and survey manager 2080 tracks progress of each respondent 134 through the survey. After responding to this first question, the respondent breaks communication with server 2002.

A survey manager 2080 cooperates with respondent interface 2005 to count the number of respondents completing the first question. In one embodiment, once sufficient (e.g., count 2010) respondents have completed the first question, survey manager 2080 instructs notifier 2022 to notify user 106 that the next question may be presented to participating respondents and awaits user 106 to provide the next question or to provide an indication that the next question of question list 2018 may be asked. In another embodiment, once sufficient (e.g., count 2010) respondents have completed the first question, survey manager 2080 automatically proceeds to the next question from question list 2018.

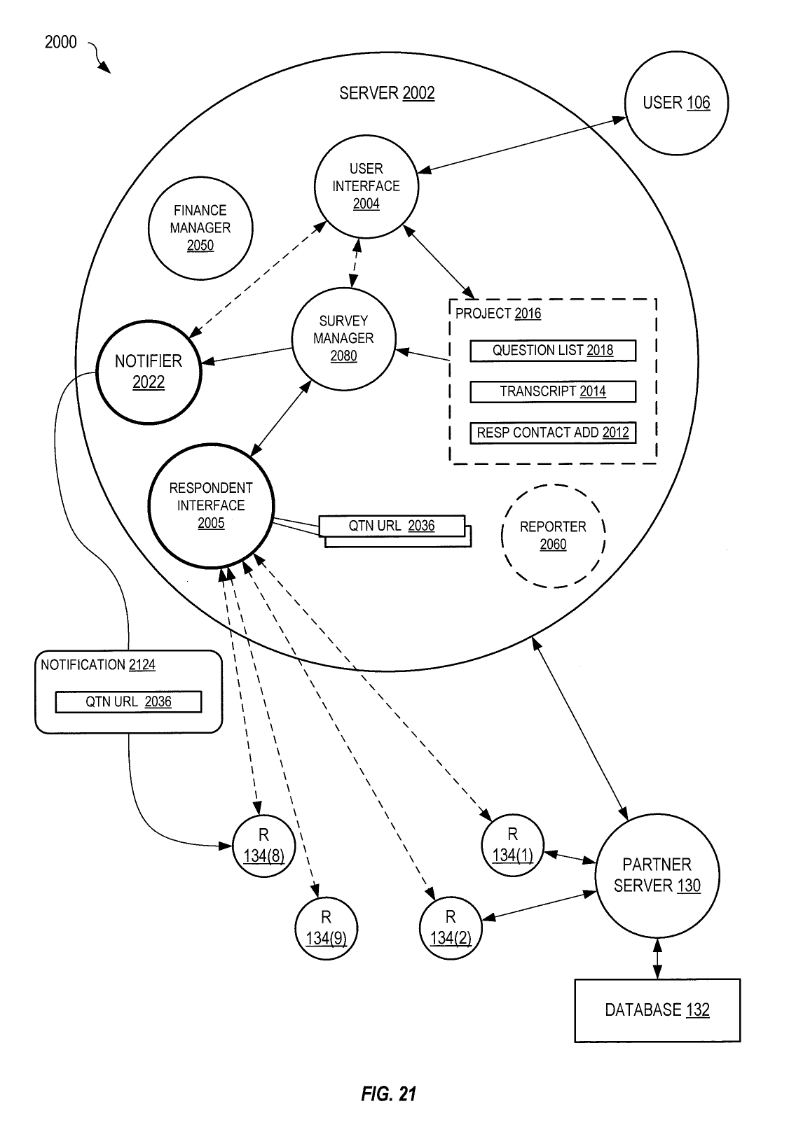

FIG. 21 shows system 2000 of FIG. 20 interacting with respondents 134 to complete the survey. FIGS. 20 and 21 are best viewed together with the following description. Respondent interface 2005 is configured with a web page addressed by a question URL 2036 and containing the next question for presentation to the respondents. Survey manager 2080 then instructs notifier 2022 to send a notification 2124 containing question URL 2036 to respondent contact address 2012 of each participating respondent 134 that has completed the first question. In one embodiment, notification 2124 is sent to respondents 134 even if they have not completed the previous question.

Upon receiving notification 2124, respondent 134 selects question URL 2036 and is reconnected with respondent interface 2005 to display the web page with the next question. Upon answering the question, respondent interface 2005 updates transcript 2014 with the respondent's answer and survey manager 2080 records the completion of the question by the respondent. Once all questions in the survey have been asked and responses recorded, a reporter 2060 may generate a report based upon transcript 2014 for display to user 106.

Each respondent 134 may respond to notification 2124 at their convenience and thus there is no time limit to complete the survey. However, a time limit (e.g., 5 days) may be defined by user 106 for answering all questions.

In one embodiment, user 106 defines a period (e.g., four hours) for identifying participants for the survey, wherein system 2000 may notify user 106 if insufficient respondents are eligible for participating in the survey. User 106 may then instruct system 2000 to solicit additional respondents 134 from partner server 130 based upon criteria 2008 and further evaluate those respondents based upon optional custom criteria 2009, as described above with respect to system 100 of FIG. 1 and system 1800 of FIG. 18. System 2000, as instructed by user 106, may solicit respondents 134 only from partner server 130 and/or alternative server 1802, as shown in FIG. 18.

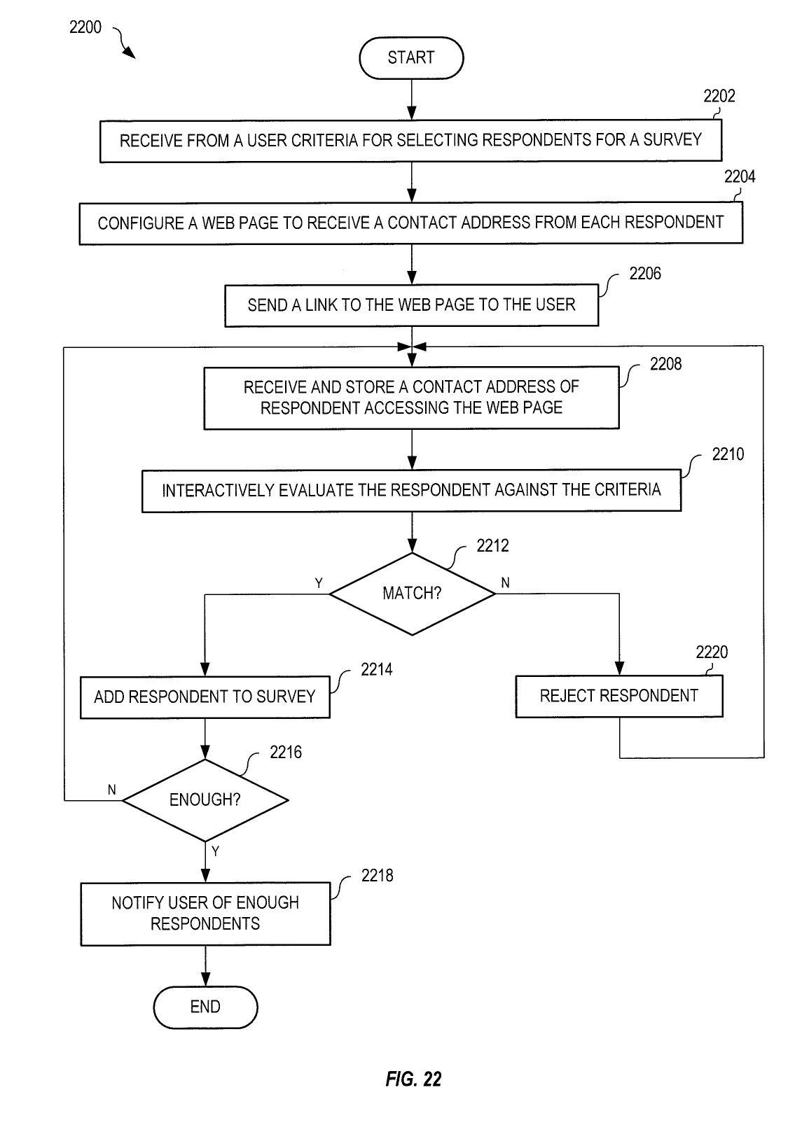

FIG. 22 is a flowchart illustrating one exemplary process 2200 for selecting respondents to participate in a survey. Process 2200 is for example implemented by user interface 2004, respondent interface 2005, and real-time evaluator 2020 of system 2000, FIGS. 20 and 21.

In step 2202, process 2200 receives, from a user, criteria for selecting respondents for a survey. In one example of step 2202, user interface 2004 receives criteria 2008 and optionally criteria 2009 from user 106. In step 2204, process 2200 configures a web page to receive a contact address from a respondent. In one example of step 2204, respondent interface 2005 is configured with a web page, addressed by invite URL 2032, to receive respondent contact address 2012. In step 2206, process 2200 sends a link to the web page to the user. In one example of step 2206, user interface 2004 displays invite URL 2032 to user 106.

In step 2208, process 2200 receives and stores a contact address of a respondent accessing the web page. In one example of step 2208, respondent interface 2005 receives respondent contact address 2012 from respondent 134(8) when the respondent accesses the web page addressed by invite URL 2032. In step 2210, process 2200 interactively evaluates the respondent against the criteria. In one example of step 2210, real-time evaluator 2020 interactively evaluates, using respondent interface 2005, respondent 134(8) against criteria 2008 and optionally custom criteria 2009.

Step 2212 is a decision. If, in step 2212, process 2200 determines that the respondent matches the criteria, process 2200 continues with step 2214; otherwise process 2200 continues with step 2220.

In step 2214, process 2200 adds the respondent to the survey. In one example of step 2214, respondent 134(8) is tracked by survey manager 2080.

Step 2216 is a decision. If, in step 2216, process 2200 determines that there are enough respondents for the survey, process 2200 continues with step 2218; otherwise process 2200 continues with step 2208. In one example of step 2216, survey manager 2080 compares a count of participating respondents 134 against respondent count 2011 and continues with step 2218 if there are enough, and continues with step 2208 is there are not enough.

In step 2218, process 2200 notifies the user of enough respondents. In one example of step 2218, survey manager 2080 instructs notifier 2022 to send a notification to user 106 indicating that there are enough respondents 134 participating in the survey and that user 106 may remove invite URL 2032 from web page 2064. In step 2220, process 2200 rejects the respondent. In one example of step 2220, respondent interface 2005 rejects respondent 134(8) for the interview and terminates communication with the respondent.

Steps 2208 through 2220 repeat for each respondent 134 selecting invite URL 2032 in response to the invitation to participate in the survey.

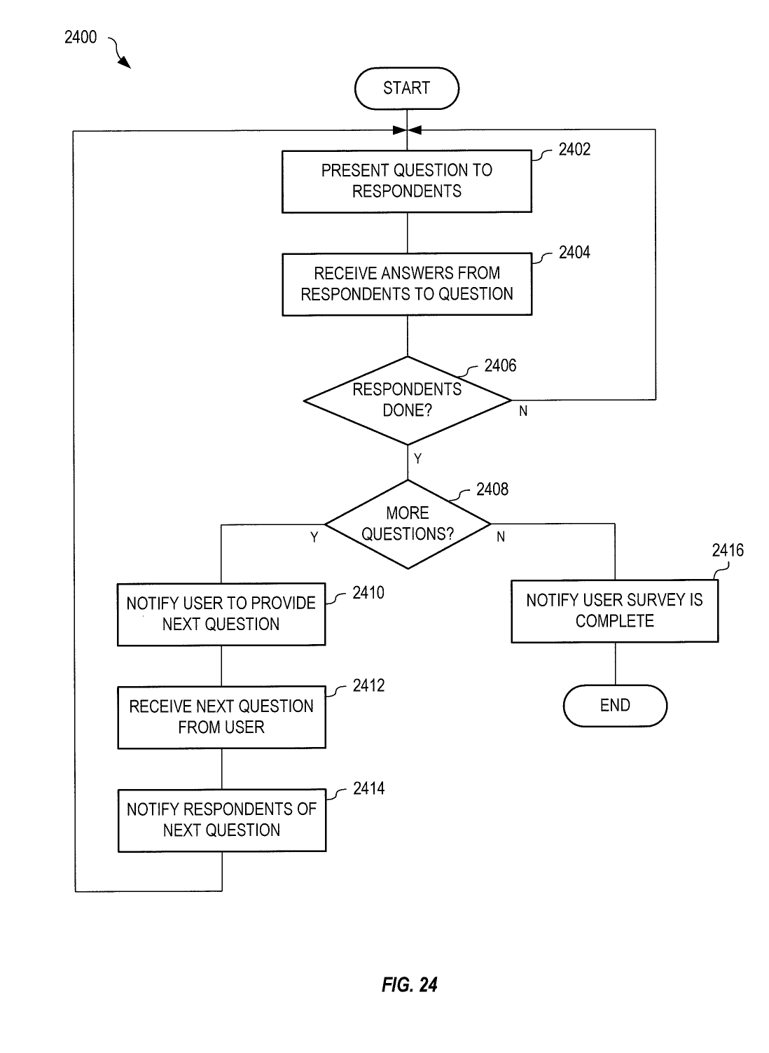

FIG. 24 is a flowchart illustrating one exemplary process 2400 for interacting with user and respondents participating in a survey. Process 2400 is for example implemented by survey manager 2080 of system 2000 after process 2200 of FIG. 22.

In step 2402, process 2400 presents a question to respondents. In one example of a first iteration of step 2402, survey manager 2080 presents a first question of question list 2018 to respondents 134 interacting with respondent interface 2005. In one example of subsequent iterations of step 2402, survey manager 2080 instructs respondent interface 2005 to present a question selected from question list 2018 by user 106 to respondents 134 interacting with respondent interface 2005. In another example of subsequent iterations of step 2402, survey manager 2080 instructs respondent interface 2005 to present a question entered or modified by user 106 to respondents 134 interacting with respondent interface 2005.

In step 2404, process 2400 receives answers from respondents to the question. In one example of step 2404, respondents interact with respondent interface 2005 to provide an answer to the question of step 2402.

Step 2406 is a decision. If, in step 2406, process 2400 determines that sufficient respondents are done answering the question of step 2402, or if a predefined time has elapsed, process 2400 continues with step 2408; otherwise process 2400 continues with step 2404 to receive more answers from respondents.

Step 2408 is a decision. If, in step 2408, process 2400 determines that there are more questions to be asked, process 2400 continues with step 2410; otherwise process 2400 continues with step 2416.

In step 2410, process 2400 notifies the user to provide the next question. In one example of step 2410, survey manager 2080 instructs notifier 2022 to send an email notification to user 106 indicating that the user should connect to system 2000 to provide a next question. In step 2412, process 2400 receives the next question from the user. In one example of step 2412, user interface 2004 receives a next question (or selection of a question from question list 2018) from user 106. In step 2414, process 2400 notifies respondents of the availability of the next question. In one example of step 2414, survey manager 2080 instructs notifier 2022 to send notification 2124 containing question URL 2036 to each respondent 134. Process 2400 continues with step 2402 for each respondent selecting the question URL 2036 within notification 2124.

In step 2416, process 2400 notifies the user that the survey is complete. In one example of step 2416, survey manager 2080 instructs notifier 2022 to send a notification message to user 106 indicating that the survey is complete.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A computer implemented real-time respondent selection and interview system, comprising:
a real-time evaluator for selecting a respondent in real-time for an interview with a user of the system, wherein the respondent is selected based upon criteria defined by the user; and
an interview manager for conducting the interview between the user and the respondent and for recording a transcript of the interview.

2. The system of claim 1, wherein the real-time evaluator receives a plurality of potential respondents from a partner server, wherein each of the plurality of potential respondents are selected by the partner server based upon (a) a match between the potential respondent and the criteria and (b) a defined period since the potential respondent has communicated with the partner server, wherein the real-time evaluator interactively evaluates each of the potential respondents against the criteria to select the respondent.

3. The system of claim 2, wherein the real-time evaluator interactively evaluates each of the potential respondents against custom criteria, provided by the user, to select the respondent.

4. The system of claim 1, further comprising a financial manager for determining a cost of conducting the interview between the user and the respondent, wherein the cost is based upon one or more of: a desired length of the interview, the criteria, and an incentive offered to the respondent to participate in the interview, wherein the cost is displayed to the user prior to selecting the respondent.

5. The system of claim 1, wherein the real-time evaluator receives, from a partner server, a count of potential respondents that match the criteria and that have communicated with the partner server within a defined period, and wherein the real-time evaluator determines a probability of selecting the respondent for interview based upon the criteria and the count, and displays the probability to the user prior to selecting the respondent.

6. The system of claim 5, wherein the real-time evaluator determines a time estimate for providing the respondent for interview with the user, wherein the time estimate is based upon the count and the probability.

7. The system of claim 1, wherein the interview is interactive between the user and the respondent.

8. The system of claim 7, wherein the interview manager displays one or more of (a) prepared questions, (b) prepared media, and (c) prepared links for selection by the user during the interview, wherein the selected questions, media, and links are interactively displayed to the respondent.

9. The system of claim 1, wherein the interview is a survey that is provided to each of a plurality of respondents, and wherein the interview manager conducts the survey by sending a notification containing a question URL to the respondent and the respondent selects the URL to view and respond to a question in the survey.

10. The system of claim 1, wherein the real-time evaluator interactively evaluates each of a plurality of potential respondents that respond to an invitation to take part in the interview from the alternative server against the criteria to select the respondent.

11. The system of claim 10, wherein the invitation is displayed by an app running on a communication device of each of the plurality of respondents, and wherein the respondent utilized the app to respond to the invitation.

12. The system of claim 10, wherein the invitation is sent to each of the plurality of potential respondents via a social networking site.

13. The system of claim 10, wherein the invitation is an invite URL that is posted on a web page viewed by each of the potential respondents, and wherein each of the potential respondents selects the invite URL to respond to the invitation.

14. A computer implemented method for real-time selection and interview of a respondent by a user, comprising the steps of:
receiving, within a server, an indication from each of a plurality of potential respondents willing to participate in the interview;
evaluating, interactively in real time, each potential respondent against criteria specified by the user;
selecting, within the server, the respondent for interview from the potential respondents that match the criteria; and
conducting the interview between the respondent and the user.

15. The method of claim 14, further comprising the steps of:
sending the criteria and a defined time window to a partner server;
receiving, from the partner server, a count of the potential respondents that match the criteria and that have communicated with the partner server within the time window;
determining, within the server, a probability of providing the respondent for interview; and
displaying the probability to the user before selecting the respondent.

16. The method of claim 15, further comprising the step of determining a time estimate for provision the respondent for the interview, wherein the time estimate is based upon one or both of the count and the probability.

17. The method of claim 14, further comprising the step of sending an invitation to participate in the interview to each of the plurality of potential respondents via a social networking site.

18. The method of claim 14, further comprising the step of sending an invitation to participate in the interview to each of the plurality of potential respondents via an app running on a communication device of the potential respondent.

19. The method of claim 14, further comprising the step of providing an invite URL to the user for display on a web page viewed by the potential respondent, wherein each of the potential respondents selects the invite URL to indicate willingness to participate in the interview.

20. The method of claim 14, further comprising the step of evaluating, interactively in real time, each potential respondent against custom criteria specified by the user, wherein the respondent is selected from potential respondents that match both the criteria and the custom criteria.
